(19) United States
(12) Patent Application Publication
(10) Pub. No.: US 2005/0019039 A1
(43) Pub. Date: Jan. 27, 2005

(54) System and method for optimized transmission in distributed Raman amplified systems operating in saturation

(75) Inventor: Nandakumar Ramanujam, Ellicott City, MD (US)

Correspondence Address: CORVIS CORPORATION;INTELLECTUAL PROPERTY DEPARTMENT, 7015 ALBERT EINSTEIN DRIVE, COLUMBIA, MD, 210469400, US

(73) Assignee: Corvis Corporation

(21) Appl. No.: 10/866,846

(22) Filed: Jun. 14, 2004

(30) Foreign Application Priority Data
Dec. 12, 2002 (WO) PCT/US02/39751

(51) Int. Cl. H04B 10/02

(52) U.S. Cl. 398/173

(57) ABSTRACT

A system and method for controlling the amplification of an optical data signal in an optical communication system having a plurality of optical fiber spans, each optical fiber span providing amplification to the optical data signal includes transmitting the optical data signal into a first optical fiber span at an input power level lower than a nominal power level. More than unity gain is provided to the optical data signal over each of at least a first group of the optical fiber spans such that the power level of the optical data signal after propagating through each of the plurality of optical fiber spans is higher than the nominal power level.

### FIELD OF THE INVENTION

The present invention relates generally to optical communications, and more particularly to a system and method for optimizing the transmission of optical signals in a distributed Raman amplified system.

### BACKGROUND OF THE INVENTION

Distributed Raman amplification (DRA) typically involves high pump powers and relatively weak signal powers. Over ultra-long-haul transmission, however, saturation effects are observed. The saturation effects self-regulate the output power of the amplifier chain. This self-regulation occurs even when the total launch power into the transmission line or recirculating loop is nearly 25 dB below the total pump power level.

For a given fiber span or loop, when the pump powers are adjusted for unity gain, a channel with a nominal launch power of about −10 dBm propagates unchanged in power. Even if the launch power is raised above the nominal launch power or lowered below the nominal launch power, the output power is held constant at the nominal launch power as a result of the self-regulation due to the saturation effect.

### SUMMARY OF THE INVENTION

Briefly, in one aspect of the invention, a method for controlling the amplification of an optical data signal in an optical communication system having a plurality of optical fiber spans, each optical fiber span providing amplification to the optical data signal includes transmitting the optical data signal into a first optical fiber span at an input power level lower than a nominal power level. More than unity gain is provided to the optical data signal over each of at least a first group of the optical fiber spans such that the power level of the optical data signal after propagating through each of the plurality of optical fiber spans is higher than the nominal power level.

In another aspect of the present invention, the amount of gain provided in each of the optical fiber spans in the first group is substantially the same.

In yet another aspect of the present invention, the number of optical fiber spans in the first group is less than the total number of optical fiber spans.

In a further aspect of the present invention, unity gain is provided to the optical data signal over each of a second group of optical fiber spans different from the first group of optical fiber spans.

### BRIEF DESCRIPTION OF THE DRAWINGS

FIG. 1 is a block diagram of a long-haul fiber optic communication system consistent with the present invention.

FIG. 2 is a block diagram of an exemplary architecture for a WDM terminal consistent with the present invention.

FIG. 3A shows the net gain for signals versus launch power for a unity gain system consistent with the present invention.

FIG. 3B shows the signal power versus transmission distance where the launch power is −10 dBm in a unity gain system consistent with the present invention.

FIG. 4 shows the affect on system performance (Q²) for a range of launch powers (P_{L}) in a unity gain system consistent with the present invention.

FIG. 5 shows the signal power versus transmission distance for multiple launch powers in a unity gain system consistent with the present invention.

FIG. 6 shows the signal power versus transmission distance for multiple launch powers in a unity gain system with adjusted steady-state powers consistent with the present invention.

FIG. 7 shows experimental simulation data for a range of launch powers used in three different optical communication system arrangements.

### DETAILED DESCRIPTION OF THE PREFERRED EMBODIMENT

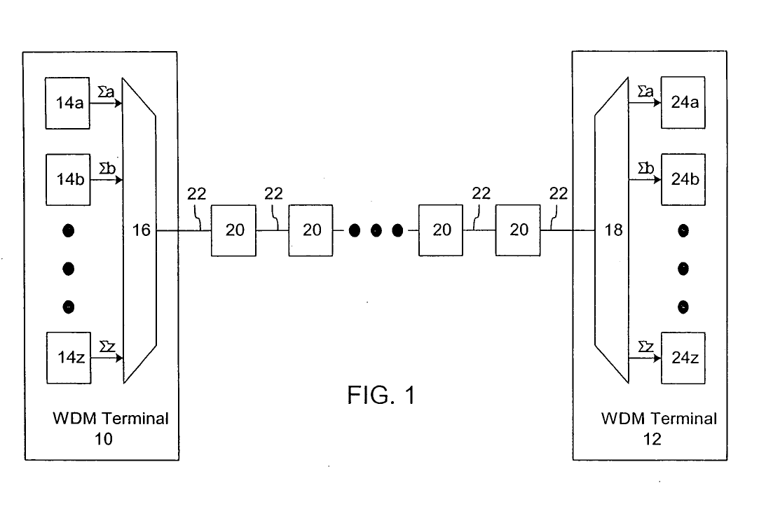

FIG. 1 is a block diagram of a long-haul fiber optic communication system consistent with the present invention. As shown in FIG. 1, the system includes a wavelength division multiplexer (WDM) terminal 10 and a WDM terminal 12. The WDM terminals 10 and 12 include a number of optical communication transmitters 14a to 14z, which respectively transmit signals at optical communications wavelengths λa to λz, where z is an integer corresponding to the total number of wavelengths being transmitted. In one aspect of the present invention, the number z of optical communications wavelengths is between approximately 200 and 400, although other numbers of wavelengths may be used. For example, the number of wavelengths may be 256, 320 or 384.

The optical communications wavelengths are multiplexed into a multiplexed optical data signal by a multiplexer 16 in WDM terminal 10, which is amplified in the transmission fiber with pump power provided by a series of pump modules 20. The multiplexed data signal is transmitted from one the WDM terminal 10 to the pump modules 20, between the pump modules 20, and from the pump modules 20 to the WDM terminal 12 via one or more transmission optical fibers 22. For pump modules 20 implemented with distributed Raman amplification, the pump module 20 will also include transmission optical fiber. The multiplexed data signal is then demultiplexed by demultiplexer 18 at the WDM terminal 12 into optical communications wavelengths λa to λz. The demultiplexed optical communications wavelengths λa to λz are received by respective optical communications receivers 24a to 24z. Although not shown, each of the WDM terminals 10 and 12 preferably include both transmission and reception components to provide bidirectional transmission.

The amplification architecture in the pump modules 20 provide pump light into optical fibers 22 and amplify the data signals traveling in the optical fibers 22. The gain profile for Raman amplification has a typical bandwidth of 20-30 nm for a single pump wavelength. For wavelength division multiplexed (WDM) optical communications applications where a broad range of wavelengths must be amplified, this 20-30 nm bandwidth is too narrow. To broaden the gain profile (gain bandwidth), Raman amplification employing multiple pump wavelengths over a broad wavelength range may be used in WDM optical communication applications. Preferably, pump wavelengths and pump power levels are selected to result in a constant or flat gain over the desired broad wavelength range.

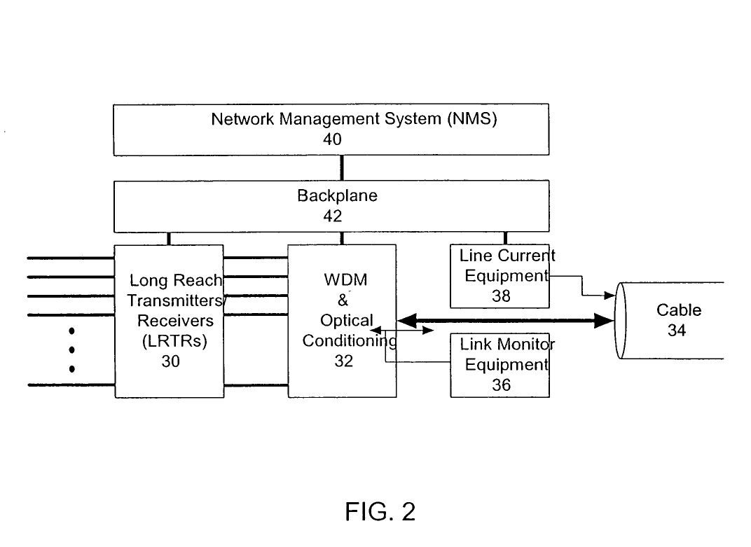

FIG. 2 is a block diagram of an exemplary architecture for a WDM terminal consistent with the present invention. In the example of FIG. 2, the terminals are connected to undersea optical communication systems, although those skilled in the art will readily appreciate that the present invention is equally applicable to devices which operate in terrestrial communication systems.

As shown in FIG. 2, long reach transmitters/receivers (LRTRs) 30 convert terrestrial signals into an optical format for long haul transmission, convert the undersea optical signal back into its original terrestrial format and provide forward error correction. The number of LRTRs 30 in each terminal will vary with the number of channels supported by the optical communication system, but may easily reach 100, 200, 300 or more per terminal. Each LRTR 30 can include a laser and a modulator, for example, and can be provided on one or more line cards which are physically mounted in shelves as described below.

A WDM and optical conditioning unit 32 multiplexes and amplifies the optical signals in preparation for their transmission over a cable 34 and, in the opposite direction, demultiplexes optical signals received from the cable 34. Enclosed within the cable 34 are the optical fibers 22. Link monitor equipment 36 monitors the optical signals and undersea equipment for proper operation. Line current equipment 38 provides power to undersea line units. A network management system (NMS) 40 controls the operation of the other components in the WDM terminal, as well as sending commands to the line units via the link monitor equipment 36, and is connected to the other components in the WDM terminal via a backplane 42.

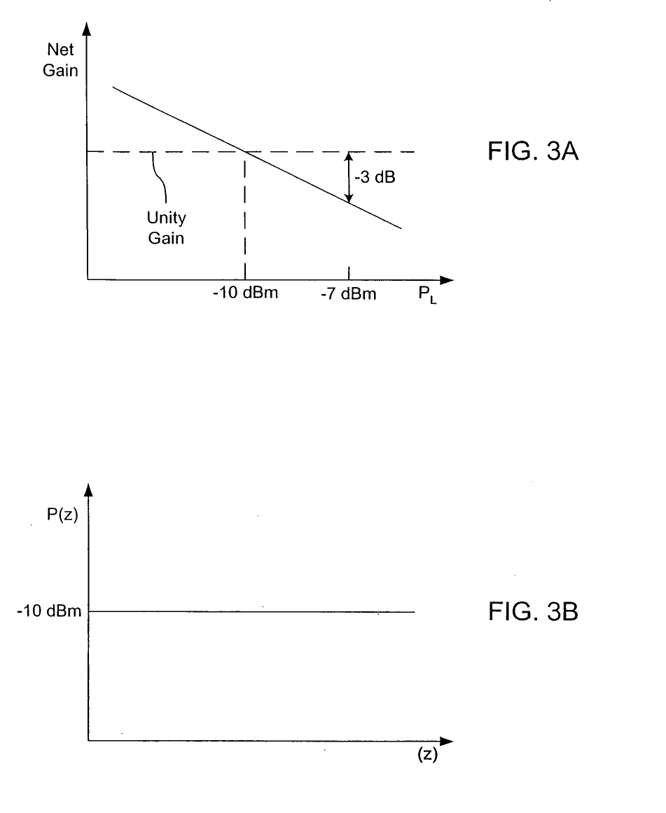

FIG. 3A shows the net gain for signals versus launch power (P_{L}) for a unity gain system. The unity gain system can be implemented by adjusting the pump powers of the pump modules 20 in the fiber optic communication system. As shown in FIG. 3A, the net gain is zero for the nominal launch power. The nominal launch power of the optical signal in this unity gain system is approximately −10 dBm. FIG. 3B shows the signal power (P(z)) versus transmission distance (z) at the nominal launch power of approximately −10 dBm in the unity gain system of FIG. 3A. As shown in FIG. 3B, the signal power remains substantially constant.

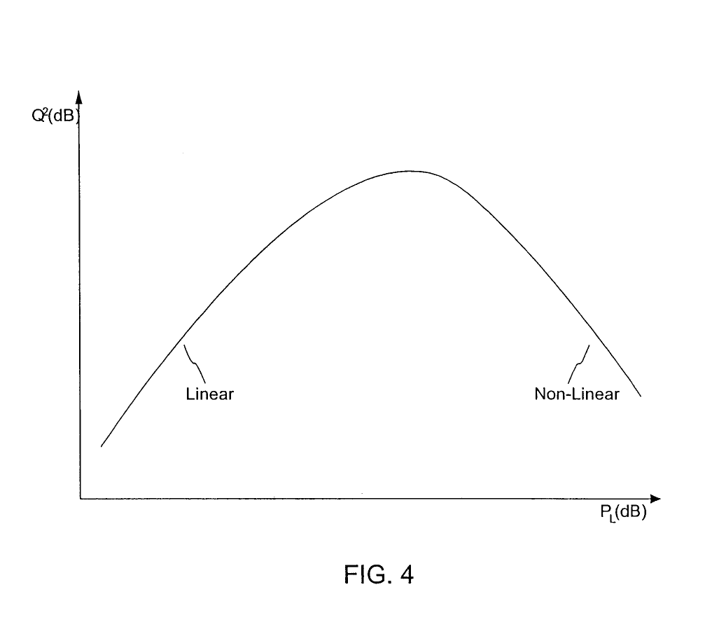

FIG. 4 shows the effect on system performance (Q²) for a range of launch powers (P_{L}) at a unity gain condition. For the unity gain condition, the optical communication system maintains the power of the signal at substantially the same power as the launch power throughout the system. As shown in FIG. 4, the lower launch powers have poorer performance primarily as a result of greater linear penalties due to increased noise. The higher launch powers have poorer performance primarily as a result of greater non-linear penalties. As can also be seen from FIG. 4, the launch power that provides the optimal system performance can be identified by from the launch power providing the highest Q² value.

Altering the launch power from the nominal launch power in a unity gain system, i.e., a system designed to provide unity gain at the nominal power level, affects the performance of the optical communication system. In particular, altering the launch power affects the linear and non-linear penalties, which determine system performance and the quality of the transmitted optical signal. In general, increasing the launch power increases the optical to signal noise ratio (OSNR), which reduces linear noise. The increased launch power, however, also increases the non-linearities. Similarly, lowering the launch power lowers the OSNR, which increases the amount of linear noise, but also reduces the amount of non-linearities.

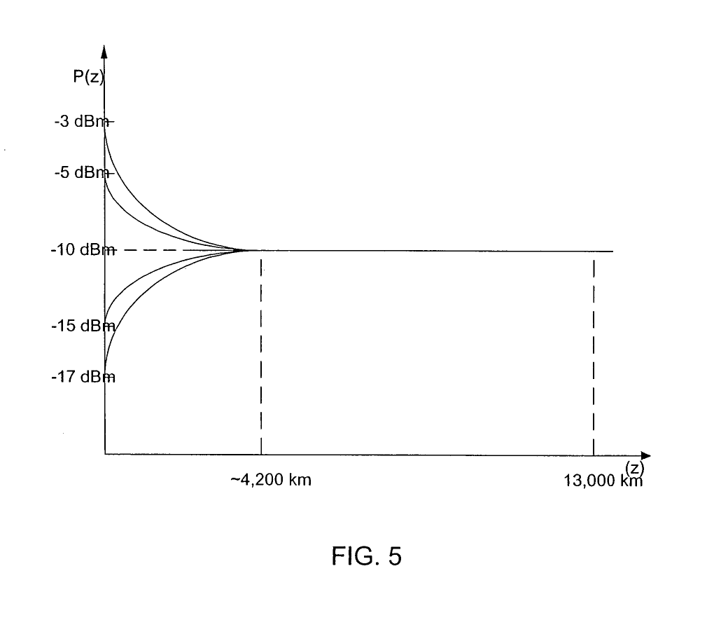

FIG. 5 shows the signal power versus transmission distance for multiple launch powers in a unity gain system. The unity gain system shown in FIG. 5 has a nominal launch power of approximately −10 dBm. If the launch power of the optical signal is increased over the nominal launch power, such as to −3 or −5 dBm, the net gain is −7 and −5 dB, respectively, as shown in FIG. 5. Because of the self-regulation due to the saturation effect, the output signal power is automatically adjusted to the nominal output power of approximately −10 dBm for each launch power. There is a limited range of launch powers, however, beyond which the required gain is not available to hold the output power constant.

As shown in FIG. 5, where the launch power is below the nominal launch power, a first section of pump modules 20 provides excess gain to the optical signal until a steady-state level is reached. The steady-state power level, which is substantially equal to the nominal launch power, is reached after approximately 4,200 km. After this first section of pump modules, the remaining pump modules 20 provide unity gain as a result of the saturation effect. Conversely, where the launch power is above the nominal launch power, a first section of pump modules 20 provides less than unity gain to the optical signal until the steady-state level is reached, and the remaining pump modules 20 provide unity gain.

In addition to altering the launch power, it is also possible to control the power evolution of the optical signal as it travels through the optical communication system. The power evolution of the optical signal can be controlled by adjusting components in the system that have an effect on the power of the optical signal as it propagates. These components include, for example, the length of the system between WDM terminals, the span lengths of the optical fibers 22 between pump modules 20, the number of pump modules 20, and the losses in each span, as well as the launch power of the optical signal.

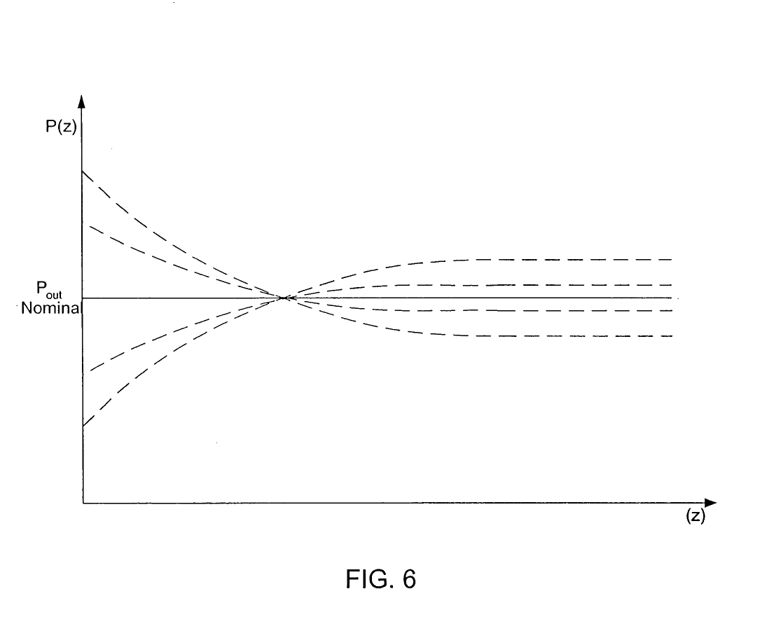

FIG. 6 shows the signal power versus transmission distance for multiple launch powers in a unity gain system with adjusted steady-state powers consistent with the present invention. As shown in FIG. 6, for launch powers greater than the nominal launch power, the steady-state power levels reached toward the end of the transmission are lower than the nominal output power. Conversely, for launch powers lower than the nominal launch power, the steady-state power levels reached toward the end of the transmission are higher than the nominal output power.

The lowered output power for the higher launch powers and the raised output power for the lower launch powers can be achieved by controlling the pump powers of the pump modules 20. For example, to get the output power of the optical signal to be higher than the nominal output power where the launch power is lower than the nominal launch power, the pump powers of the pump modules 20 may be increased. The increased pump power can be adjustable depending on the position of each pump module 20. More preferably, each pump module is configured to provide the same amount of pump power, with the amount provided being sufficient to raise the output power of the optical signal to be greater than the nominal output power. For the launch powers that are greater than the nominal launch power, the pump powers of the pump modules 20 may be decreased, either by adjusting the pump power depending on the position of each pump module 20 or configuring each pump module 20 to have the same amount of pump power sufficient to lower the output power of the optical signal to be lower than the nominal output power.

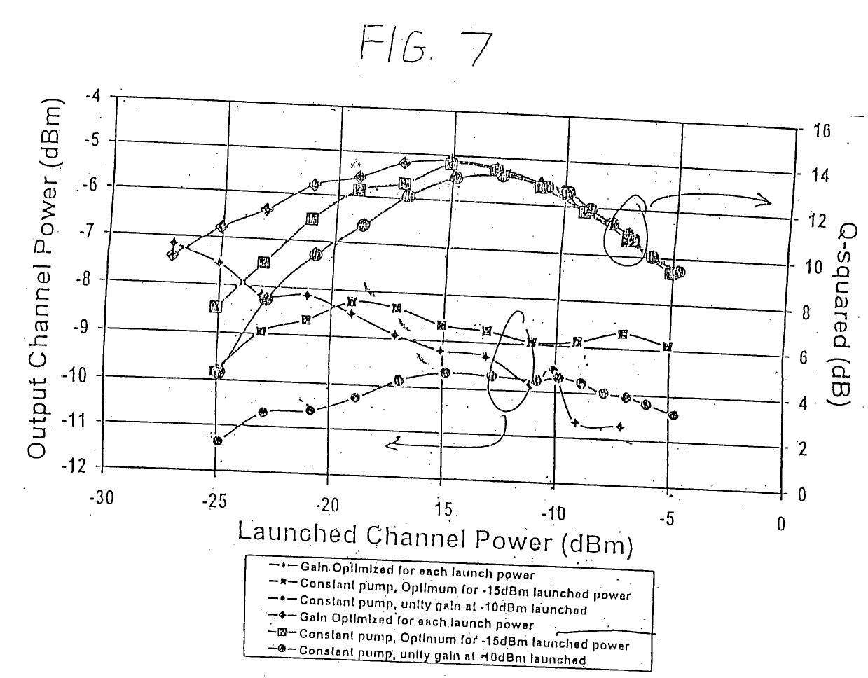

FIG. 7 shows experimental simulation data for a range of launch powers used in three different optical communication system arrangements. The first arrangement is a unity gain system having a nominal power level of approximately 10 dBm. The second arrangement is for an optical communication system configured for optimal transmission at 15 dBm. The third arrangement is for an optical communication system optimized for each launch power.

The data shown in FIG. 7 show both the output power for each launch power in each arrangement, as well as the system performance (Q²) for each launch power in each arrangement. As shown in FIG. 7, the best system performance is achieved where the optical communication system is optimized for launch powers between approximately −13 dBm and −17 dBm. For such launch powers, the output powers range between just below −9 dBm to just above −9 dBm.

Based on the experimental data of FIG. 7, when the launch power drops significantly from the nominal launch power, system performance can be improved by providing excess or net gain so that the steady-state power is greater than the nominal output power. Conversely, when the launch power is much higher than normal, system performance is improved by reducing the net gain. These actions provide a balance between OSNR improvement and the non-linear penalty.

For a given fiber map with associated span loss, as well as a set of pump levels to obtain unity gain, it is possible to achieve an optimum launch power level. Deviation from this launch power is corrected optimally by both automatic gain recovery due to saturation, as well as pump adjustment to provide the greatest tolerance. The optimal transmission condition is one where the power evolves from less than the nominal power level, receives net excess gain, and reaches a steady-state power level that is greater than the nominal output power level.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

1. A method for controlling the amplification of an optical data signal in an optical communication system having a plurality of optical fiber spans, each optical fiber span providing amplification to the optical data signal, the method comprising:
transmitting the optical data signal into a first optical fiber span at an input power level lower than a nominal power level; and
providing more than unity gain to the optical data signal over each of at least a first group of the optical fiber spans such that the power level of the optical data signal after propagating through each of the plurality of optical fiber spans is higher than the nominal power level.

2. A method according to claim 1, wherein the amount of gain provided in each of the optical fiber spans in said first group is substantially the same.

3. A method according to claim 2, wherein the number of optical fiber spans in the first group is less than the total number of optical fiber spans.

4. A method according to claim 3, further comprising:
providing unity gain to the optical data signal over each of a second group of optical fiber spans different from the first group of optical fiber spans.

5. A method according to claim 4, wherein the step of providing unity gain includes limiting the gain provided to the optical data signal due to a saturation effect.

6. A method according to claim 1, wherein the amplification provided by the optical fiber spans is distributed Raman amplification.

7. A method according to claim 6, where the Raman amplification is provided by a set of one or more pumps for each corresponding optical fiber span.

8. A method according to claim 7, further comprising:
setting a total pump power for each set of one or more pumps to be the same.

9. A system for controlling the amplification of an optical data signal in an optical communication system, comprising:
a plurality of optical fiber spans, a first one of the optical fiber spans receiving the optical data signal at an input power level lower than a nominal power level; and
a plurality of amplification stages, each amplification stage coupled to and corresponding to a respective one of the optical fiber spans and providing amplification to the optical data signal propagating in the respective optical fiber span,
wherein at least a first group of the amplification stages provide more than unity gain to the optical data signal in the respective optical fiber spans such that the power level of the optical data signal after propagating through each of the plurality of optical fiber spans is higher than the nominal power level.

10. A system according to claim 9, wherein the amount of gain provided by each of the amplification stages in the first group is substantially the same.

11. A system according to claim 10, wherein the number of optical fiber spans in the first group is less than the total number of optical fiber spans.

12. A system according to claim 11, wherein a second group of amplification stages, different from the first group of amplification stages, provide unity gain to the optical data signal in the respective optical fiber spans.

13. A system according to claim 12, wherein the unity gain provided by the second group of amplification stages is limited due to a saturation effect.

14. A system according to claim 9, wherein the amplification stages provide distributed Raman amplification.

15. A system according to claim 14, wherein each of the amplification stages includes a set of one or more pumps.

16. A system according to claim 15, wherein a total pump power for each set of one or more pumps is the same.

17. A method for controlling the amplification of an optical data signal in an optical communication system having a plurality of optical fiber spans, each optical fiber span providing amplification to the optical data signal, the method comprising the steps of:
launching the optical data signal into a first optical fiber span at an input power level lower than a nominal power level;
providing more than unity gain to the optical data signal over each of at least a first group of the optical fiber spans such that the power level of the optical data signal after propagating through each of the plurality of optical fiber spans is substantially at the nominal power level; and
providing unity gain to the optical signal over each of a second group of optical fiber spans which follow the first group of optical fiber spans.

18. The method of claim 17, wherein said steps of providing more than unity gain and unity gain to said first and second groups of optical fiber spans further comprises the steps of coupling laser pump energy to said first and second groups of optical fiber spans.

19. The method of claim 18, wherein substantially the same amount of pump energy is coupled to both said first and second groups of optical fiber spans.

20. The method of claim 19, wherein said second group of optical fiber spans provides unity gain due to a saturation effect.

21. The method of claim 17, wherein said first group of optical fiber spans are disposed over a first 4,200 km including said first optical fiber span and said second group of optical fibers are concatenated thereto.
